(19) United States
(12) Patent Application Publication
(10) Pub. No.: US 2026/0195622 A1
(43) Pub. Date: Jul. 9, 2026

(54) SYSTEMS AND METHODS FOR CARBON DIOXIDE STORAGE

(71) Applicant: Schlumberger Technology Corporation, Sugar Land, TX (US)

(72) Inventors: Melanie Jensen, Cambridge, MA (US); Jeffrey Miles, Cambridge, MA (US); Peter Tilke, Cambridge, MA (US); Smaine Zeroug, Cambridge, MA (US)

(21) Appl. No.: 19/012,105

(22) Filed: Jan. 7, 2025

(51) Int. Cl. G06Q 30/018; G06N 7/01

(52) U.S. Cl. CPC G06N 7/01; G06F 30/00; G06F 2111/08; G06F 2111/10; Y02C 20/40

(57) ABSTRACT

Systems and methods for carbon dioxide storage are provided. A method, includes: providing a probabilistic graphical model (PGM) including: a first layer including a storage site potential node providing a determination of a potential for carbon dioxide (CO₂) storage for a candidate site, and a second layer including: a second plurality of nodes for performance metrics, and a third plurality of nodes for geological site properties, wherein: each node in the second layer provides an input to one or more of the first layer and another node in the second layer, and the first layer receives inputs from the second layer, and providing one or more of: the determined potential for CO₂ storage for the candidate site, or respective values for at least one of: the storage site potential node, one or more of the second plurality of nodes, or one or more of the third plurality of nodes.

### TECHNICAL FIELD

This disclosure generally relates to systems and methods for carbon dioxide storage.

### BACKGROUND

Geological sequestration or storage of carbon dioxide (CO₂) provides a method for the reduction of CO₂ emissions into the atmosphere. Three criteria for a geological site to be suitable for CO₂ storage are:
Capacity: the site has adequate pore volume to store large amounts of CO₂;
Injectivity: the site allows for the desired injection rate of the CO₂ over a desired period of time; and
Containment: the site prevents the injected CO₂ from escaping into the surface or leaking into neighboring formations.

These three criteria depend on a variety of geological and petrophysical properties of the candidate storage site. The quantification of key site properties along with their uncertainties is vital in assessing the potential of a geological site. It enables modeling and simulations of the complex processes involved in CO₂ storage that are required to evaluate key performance metrics and risk quantities, such as CO₂ leakage rates or total volume of CO₂ stored. There are additional criteria for assessing a candidate storage site, such as economic cost, regulatory conditions, and social conditions. The Unites States Department of Energy National Energy Technology Laboratory developed a set of best practices for this problem in 2017, which included criteria to be considered.

Accordingly, there is a need for systems and methods for selection, ranking, and evaluation of a possible geological storage site for carbon dioxide (CO₂) storage.

### SUMMARY

This disclosure pertains to systems and methods for carbon dioxide (CO₂) storage.

A first aspect of this disclosure pertains to a method, including: providing a probabilistic graphical model (PGM) including: a first layer including a storage site potential node providing a determination of a potential for carbon dioxide (CO₂) storage for a candidate site, and a second layer including: a second plurality of nodes, the second plurality of nodes respectively corresponding to a plurality of performance metrics, and a third plurality of nodes, the third plurality of nodes respectively corresponding to a plurality of geological site properties, wherein: each node in the second layer is configured to provide an input to one or more of the first layer and another node in the second layer, and the first layer is configured to receive inputs from the second layer, and operating the PGM to provide one or more of: the determination of the potential for CO₂ storage for the candidate site, or respective values for at least one of: the storage site potential node, one or more of the second plurality of nodes, or one or more of the third plurality of nodes.

A second aspect of this disclosure pertains to the method of the first aspect, wherein: the second plurality of nodes respectively include: a capacity, a no-go condition, an injectivity difficulty, and a containment risk, and the third plurality of nodes respectively include: a legal condition, a salinity, a seal thickness, and a well leakage risk.

A third aspect of this disclosure pertains to the method of the first aspect, and further includes: setting respective values for the one or more of the third plurality of nodes to have equal probabilities, determining respective values for the one or more of the second plurality of nodes based on the set respective values for the one or more of the third plurality of nodes, and determining the values for the storage site potential node based on the determined respective values for the one or more of the second plurality of nodes.

A fourth aspect of this disclosure pertains to the method of the third aspect, and further includes: setting respective values for another of the one or more of the second plurality of nodes to have equal probabilities, wherein the determining the values for the storage site potential node is further based on the set respective values for the one or more of the second plurality of nodes.

A fifth aspect of this disclosure pertains to the method of the first aspect, and further includes: setting respective values for the one or more of the third plurality of nodes to have known probabilities, determining respective values for the one or more of the second plurality of nodes based on the set respective values for the one or more of the third plurality of nodes, and determining the values for the storage site potential node based on the determined respective values for the one or more of the second plurality of nodes.

A sixth aspect of this disclosure pertains to the method of the fifth aspect, and further includes: setting respective values for another of the one or more of the second plurality of nodes to have known probabilities, wherein the determining the values for the storage site potential node is further based on the set respective values for the one or more of the second plurality of nodes.

A seventh aspect of this disclosure pertains to the method of the first aspect, and further includes: setting values for the storage site potential node to have known probabilities, setting respective values for the one or more of the third plurality of nodes to have known probabilities, determining respective values for the one or more of the second plurality of nodes based on the set respective values for the one or more of the third plurality of nodes, and determining the values for another one or more of the second plurality of nodes or for another one or more of the third plurality of nodes based on the determined respective values for the one or more of the second plurality of nodes.

An eighth aspect of this disclosure pertains to the method of the seventh aspect, and further includes: setting respective values for at least a third of the one or more of the second plurality of nodes to have known probabilities, wherein the determining the values for another one or more of the second plurality of nodes or for another one or more of the third plurality of nodes is further based on the set respective values for the one or more of the second plurality of nodes.

A ninth aspect of this disclosure pertains to the method of the first aspect, and further includes: assigning a rank to each of a plurality of candidate sites based on the determination of the potential for CO₂ storage for each candidate site, selecting a top-ranked site among the plurality of candidate sites as a CO₂ storage site, and injecting the CO₂ into the CO₂ storage site.

A tenth aspect of this disclosure pertains to the method of the ninth aspect, wherein the CO₂ is injected into the CO₂ storage site as one or more of: a gas, a solid, a liquid, a supercritical fluid, or CO₂ dissolved in another fluid.

An eleventh aspect of this disclosure pertains to the method of the first aspect, wherein the PGM includes one or more of: a factor graph, a Markov random field, a Bayesian network, a decision network, a causal map, or a decision tree.

A twelfth aspect of this disclosure pertains to a system, including: one or more processors, a non-transitory computer-readable medium storing instructions that, when executed, cause the one or more processors to: provide a probabilistic graphical model (PGM) including: a first layer including a storage site potential node providing a determination of a potential for carbon dioxide (CO₂) storage for a candidate site, and a second layer including: a second plurality of nodes, the second plurality of nodes respectively corresponding to a plurality of performance metrics, and a third plurality of nodes, the third plurality of nodes respectively corresponding to a plurality of geological site properties, wherein: each node in the second layer is configured to provide an input to one or more of the first layer and another node in the second layer, and the first layer is configured to receive inputs from the second layer, and operate the PGM to provide one or more of: the determination of the potential for CO2 storage for the candidate site, or respective values for at least one of: the storage site potential node, one or more of the second plurality of nodes, or one or more of the third plurality of nodes.

A thirteenth aspect of this disclosure pertains to the system of the twelfth aspect, wherein: the second plurality of nodes respectively include: a capacity, a no-go condition, an injectivity difficulty, and a containment risk, and the third plurality of nodes respectively include: a legal condition, a salinity, a seal thickness, and a well leakage risk.

A fourteenth aspect of this disclosure pertains to the system of the twelfth aspect, wherein the instructions further cause the one or more processors to: set respective values for the one or more of the third plurality of nodes to have equal probabilities, determine respective values for the one or more of the second plurality of nodes based on the set respective values for the one or more of the third plurality of nodes, and determine the values for the storage site potential node based on the determined respective values for the one or more of the second plurality of nodes.

A fifteenth aspect of this disclosure pertains to the system of the fourteenth aspect, wherein the instructions further cause the one or more processors to: set respective values for another of the one or more of the second plurality of nodes to have equal probabilities, wherein the determining the values for the storage site potential node is further based on the set respective values for the one or more of the second plurality of nodes.

A sixteenth aspect of this disclosure pertains to the system of the twelfth aspect, wherein the instructions further cause the one or more processors to: set respective values for the one or more of the third plurality of nodes to have known probabilities, determine respective values for the one or more of the second plurality of nodes based on the set respective values for the one or more of the third plurality of nodes, and determine the values for the storage site potential node based on the determined respective values for the one or more of the second plurality of nodes.

A seventeenth aspect of this disclosure pertains to the system of the sixteenth aspect, wherein the instructions further cause the one or more processors to: set respective values for another of the one or more of the second plurality of nodes to have known probabilities, wherein the determining the values for the storage site potential node is further based on the set respective values for the one or more of the second plurality of nodes.

An eighteenth aspect of this disclosure pertains to the system of the twelfth aspect, wherein the instructions further cause the one or more processors to: set values for the storage site potential node to have known probabilities, setting respective values for the one or more of the third plurality of nodes to have known probabilities, determine respective values for the one or more of the second plurality of nodes based on the set respective values for the one or more of the third plurality of nodes, and determine the values for another one or more of the second plurality of nodes or for another one or more of the third plurality of nodes based on the determined respective values for the one or more of the second plurality of nodes.

A nineteenth aspect of this disclosure pertains to the system of the eighteenth aspect, wherein the instructions further cause the one or more processors to: set respective values for at least a third of the one or more of the second plurality of nodes to have known probabilities, wherein the determining the values for another one or more of the second plurality of nodes or for another one or more of the third plurality of nodes is further based on the set respective values for the one or more of the second plurality of nodes.

A twentieth aspect of this disclosure pertains to the system of the twelfth aspect, wherein the instructions further cause the one or more processors to: assign a rank to each of a plurality of candidate sites based on the determination of the potential for CO₂ storage for each candidate site, select a top-ranked site among the plurality of candidate sites as a CO₂ storage site, and send a signal to an injection device to inject the CO₂ into the CO₂ storage site.

A twenty-first aspect of this disclosure pertains to the system of the twentieth aspect, wherein the CO₂ is injected into the CO₂ storage site as one or more of: a gas, a solid, a liquid, a supercritical fluid, or CO₂ dissolved in another fluid.

A twenty-second aspect of this disclosure pertains to the system of the twelfth aspect, wherein the PGM includes one or more of: a factor graph, a Markov random field, a Bayesian network, a decision network, a causal map, or a decision tree.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a graph of a Bayesian Network in accordance with an example embodiment of the present disclosure.

FIG. 2 is a graph of a simplified Bayesian Network in accordance with an example embodiment of the present disclosure.

FIG. 3 is a graph of a simplified Bayesian Network in accordance with an example embodiment of the present disclosure.

FIG. 4 is a graph of a simplified Bayesian Network in accordance with an example embodiment of the present disclosure.

FIG. 5 is a flowchart of a method in accordance with an example embodiment of the present disclosure.

FIG. 6 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

Example embodiments of the present disclosure may use probabilistic graphical models (PGMs) to select and rank geological storage sites. One objective is to assess the potential of candidate geological sites for carbon dioxide (CO₂) sequestration. For example, CO₂ from a surface facility, e.g., a factory, an industrial cement production facility, a steel refinery, etc., may have a need to dispose of waste CO₂ by safely storing it (e.g., sequestering the CO₂) underground. To determine locations that are good for such sequestration, a determination may be made as to how much CO₂ can be injected into the site over a given number of years. The determination may be based on the ability to store CO₂ in a gas form or to convert the CO₂ to a solid form (e.g., mineral carbon) for storage. The CO₂ may be injected and stored, for example, as a gas, a solid, a liquid, a supercritical fluid, or CO₂ dissolved in another fluid, such as water.

In example embodiments, a graph (or chart or network) of key criteria and relationships between criteria may be built that can be used in a predictive and diagnostic manner to assess the potential of each candidate site. The predictive approach takes new information about the criteria to evaluate the potential of the candidate storage site, whereas the diagnostic approach uses the potential of the candidate storage site to assess the criteria or required inputs.

Example embodiments of the present disclosure may provide modeling of the relationships between properties of the geological storage site, and the incorporation of domain knowledge, uncertainty, and data. Example embodiments may enable a choice of models that are based on physical calculations or on observed data. Conventional solutions do not model the relationship between site properties, or do not propagate uncertainties in a coherent manner, or do not allow information to flow between properties, or do not enable diagnostic conclusions about required input criteria.

Example embodiments of the present disclosure may include a method for selecting, ranking, and evaluating a possible geological site for carbon dioxide storage that accounts for dependencies between quantities of interest, uncertainty about site properties, domain knowledge, and observations. An example method can be used as a predictive and diagnostic tool. Example embodiments can reduce the risk in the decision-making process for determining whether a given proposed site should be used for CO₂ storage. Embodiments may also include actually storing the CO₂ in a candidate site determined to have a good or very good storage site potential, e.g., sites determined to be desirable or very desirable for CO₂ storage.

Conventionally, multiple-criteria decision analysis (MCDA) methods have been proposed to screen and rank candidate storage sites for CO₂ storage. These conventional methods can be summarized as requiring:
a set of criteria (and possibly sub-criteria);
criteria weights;
a set of functions that assigns a score/value to each candidate storage site for each criterion; and
score weights.

The output of these conventional methods is either a score for each candidate site or a relative ranking of the candidate sites. The methods differ by how these four components are defined and combined. Some examples of mathematical frameworks and MCDA methods include analytic hierarchy process (AHP), a technique for the order of prioritization by similarity to the ideal solution (TOPSIS), and a weighted sum.

Probabilistic graphical models (PGM) are a method of assessing a system given key variables and relationships between variables. They are defined by two components: a graph and a set of functions. The graph is comprised of nodes and edges. The nodes represent variables of interest (which may be deterministic or probabilistic), variables that can be controlled by a decision maker, or measures of desirability. The edges of the graph represent relationships between variables and can be directed or undirected. Directed edges represent causal relationships. The set of functions provide a functional form for the relationship between connected nodes. Each function takes some combination of the variables/nodes in the graph and maps them to the real line (e.g., conditional probability distribution, unnormalized measure).

A Bayesian Network (BN) is an example of a PGM. In a BN, all nodes in the graph are variables of interest and are modeled as random variables, and the graph has directed edges indicating probabilistic dependence. The set of functions are the conditional probability distributions in which each function corresponds to a node in the graph. The argument of each function are those nodes with arrows pointing to the corresponding node. The output of each function is a number between zero and one.

Bayesian Networks have been proposed within the carbon storage community, but for a limited set of purposes. They have been developed to assess the containment and leakage risk of a geological storage site, CO₂ plume detection and stabilization, and CO₂ monitoring. The assessment of the containment/leakage risk is a single component of the site selection and ranking problem that is targeted by example embodiments of the present disclosure.

Example embodiments may use probabilistic graphical models (PGM) to assess the potential of candidate geological sites for CO₂ sequestration. This method can be applied to screen, rank, select, and further characterize candidate geological sites.

A first component of an example embodiment is a graph. The nodes of the graph may be at least the set of criteria (e.g., “criteria nodes”) used to assess the storage potential and a node that represents the overall potential for CO₂ storage. Additionally, there can be nodes that represent properties of the storage site or quantities that impact specific criteria, which may be referred to as “property” nodes. The criteria nodes and property nodes can be modeled as deterministic or probabilistic variables. Values for the nodes can be categorical, e.g., having a discrete number of states, or may be continuous. Continuous nodes may be approximated by discrete nodes, depending on the structure of the graph. The criteria nodes may not be directly controlled by a decision maker, but may be observed or estimated using measurements, simulations, or domain knowledge. Additionally, the graph can contain nodes that represent actions under the control of the decision maker and variables that measure the desirability of an action. The edges of the graph can be directed or undirected. Directed edges between two nodes may indicate a conditional dependency. The structure of the graph can be constructed from an academic “expert” opinion, e.g., based on theory or calculation, or can be learned using data. The data can be collected from historical measurements, direct measurement, process-based models, and/or simulators.

A second component of an example embodiment is a set of functions. The set of functions may define the relationship between the connected nodes. Each function may take in a combination of the nodes, and may output a real number. These functions can be defined by domain experts or may be learned using data. If a PGM is a Bayesian Network, then the set of functions may include the conditional probability distributions, e.g., one function for each node. If the PGM is a Decision Network, then the set of functions may include the conditional probability distributions, the decision functions, and utility functions. The set of functions can be defined from an academic “expert” opinion, e.g., based on theory or calculation, or can be learned using data. The data can be collected from historical measurements, direct measurement, process-based models, and/or simulators.

Once the two components of the probabilistic graphical model are defined, the candidate storage sites can be assessed. For a given candidate site, information may be gathered about the key criteria and site properties. The information can come, for example, from experts, historical data, new data, and/or simulations. For each variable with new information, the state of the corresponding node may be updated. The node can be believed to be in a single state or in multiple states with differing likelihood (or probability). This process of updating the state of the node may be referred to as “setting evidence.” Then, using an inference propagation algorithm, the evidence may be propagated through the network to update nodes that do not have any associated evidence with inferred values.

The PGM can be used in a predictive manner to estimate the potential of a candidate site when evidence is placed on a subset or on all criteria and property nodes. The evidence may be propagated through the network to update the state of the node representing the overall potential for CO₂ storage. The state of this node may provide a measure of how suitable the potential site will be for CO₂ storage and can be used to compare the potential (or candidate) geological sites. Alternatively, by placing evidence on a subset of the criteria nodes and property nodes along with the state of the node representing the overall potential, the PGM can be used in a diagnostic manner to estimate the criteria values to ensure a specified storage potential. In this case, evidence may propagate through the network to update the criteria nodes that do not have associated evidence. This may be beneficial when a criteria value is unknown.

### Example 1

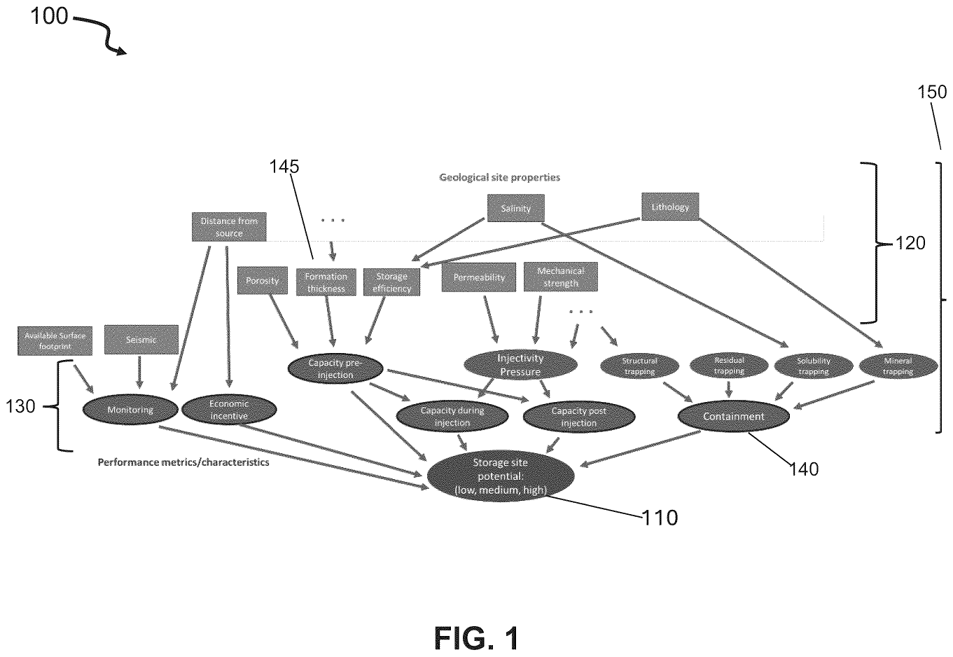

FIG. 1 is a graph of a Bayesian Network in accordance with an example embodiment of the present disclosure.

In FIG. 1, a Bayesian Network 100 may assess the potential of a candidate CO₂ storage site. The FIG. 1 Bayesian Network may identify key criteria and relationships for storage site potential at a first node 110 in a first layer. Rectangles in a top section (third plurality of nodes 120) denote geological site properties that can be measured or inferred from measurements, ovals in a middle section (second plurality of nodes 130) denote different criteria for assessing the potential for storing CO₂.

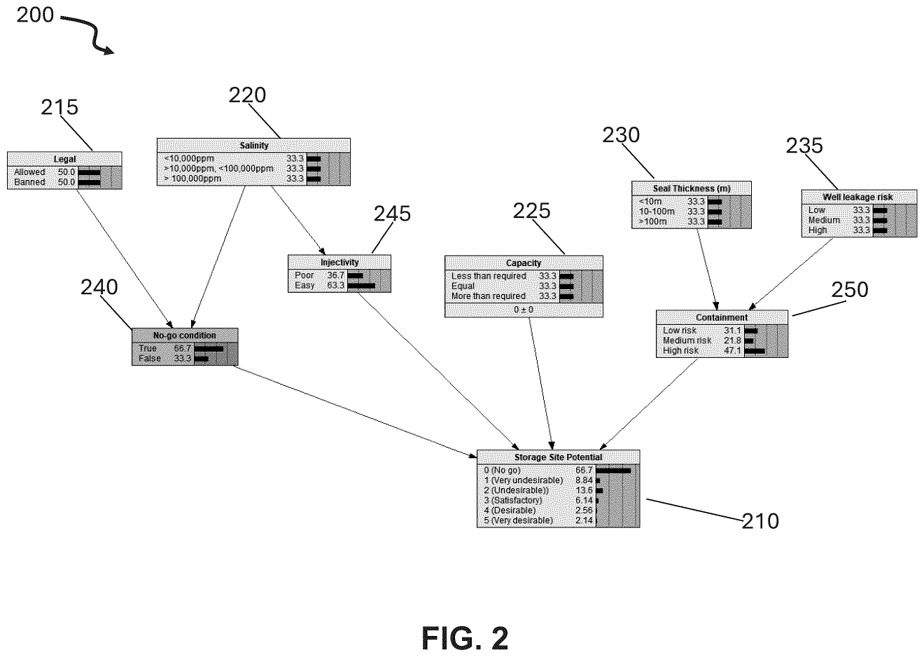

The network 100, may include geological properties of the storage site (rectangles in a third plurality of nodes 120) that may influence the different criteria for assessing the potential for storing CO₂ (ovals in a second plurality of nodes130). Causal dependencies between the properties and criteria are shown by the arrows. The final node, e.g., first node 110 in the first layer, without any arrows pointing out, is the variable that may evaluate the storage site potential, e.g., as low, medium, or high in the illustrated example. It should be appreciated that the example of “low, medium, or high” is nonlimiting; for example, other text or numerical values may be used. It is the value of this node that can be computed for each candidate site and may be used to rank all candidate sites. The set of functions would be a set of conditional probability distributions, one corresponding to each node. For example, a corresponding function for a “Containment” node 140 may take arguments, e.g., structural trapping, residual trapping, solubility trapping, and mineral trapping, and may output the probability of the state of containment conditional on the state of the arguments. As another example, a node 145 for “Storage efficiency” may take Salinity and Lithology as input arguments. The conditional probability distribution for Storage efficiency may be derived from a physical model or from a simulation that uses these arguments, which may then be used to define a discrete or continuous function for the probability distribution. Such a physical model may account for processes including, but not limited to, CO₂ solubility, geochemical reactions, pore-size distributions, or other geophysical attributes and phenomena when computing storage efficiency using the input arguments. In other embodiments, a conditional probability distribution may be derived from real-world data, laboratory measurements, observations, and/or expert knowledge and definitions. The second plurality of nodes 130 and the third plurality of nodes 120 may both be considered to be in a same second layer 150, or may be considered to be two separate layers, depending on the desired PGM architecture. It should be appreciated that the particular properties, metrics, and characteristics shown for the nodes in FIG. 2 are nonlimiting, and these and/or other properties, metrics, and characteristics may be used.

### Example 2

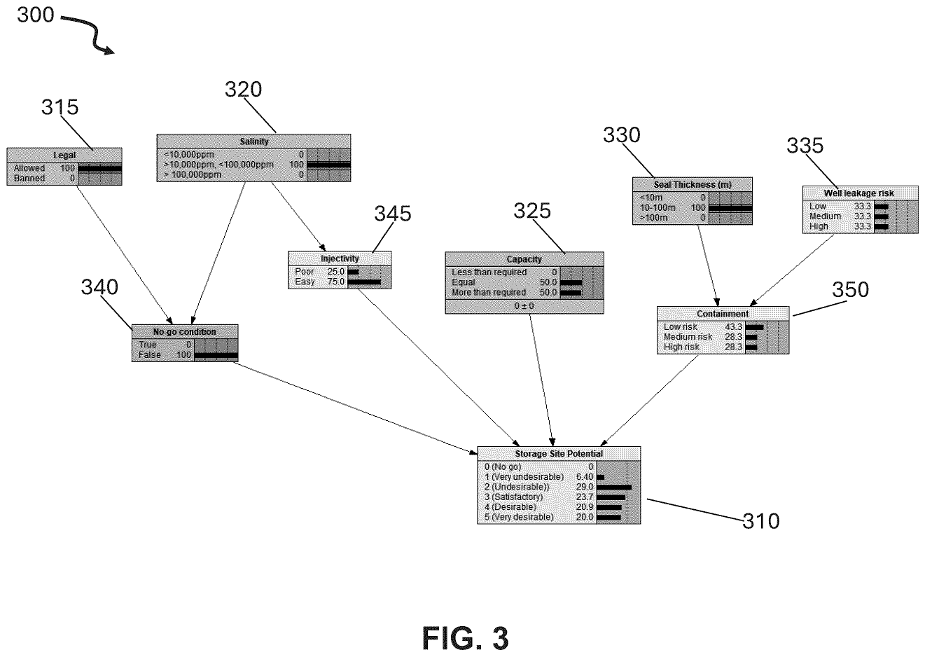

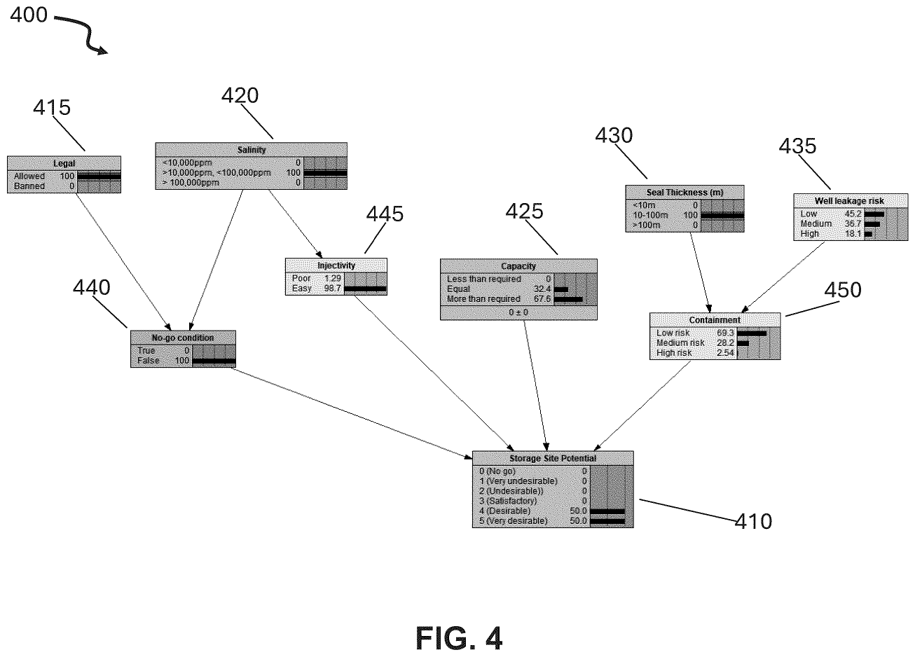

FIG. 2 is a graph of a simplified Bayesian Network in accordance with an example embodiment of the present disclosure. FIG. 3 is a graph of a simplified Bayesian Network in accordance with an example embodiment of the present disclosure. FIG. 4 is a graph of a simplified Bayesian Network in accordance with an example embodiment of the present disclosure.

FIG. 2 shows a simplified Bayesian Network 200 that may assess storage site potential for CO₂ storage, with values set to reflect a scenario with no evidence. The storage site potential may depend on the capacity, injectivity, containment, and whether the site satisfies basic regulatory requirements. The injectivity may depend on the salinity of the storage site, and the containment may depend on the seal thickness and well leakage risk of the potential storage site.

Values in this example are set to reflect a scenario with no evidence, e.g., the site properties have uniform probability distributions. The bottom node 210 entitled “Storage Site Potential” is the variable that may be used to score/rank different candidate storage sites. The key criteria that are being considered in the FIG. 2 example are capacity, injectivity, containment, and whether the site satisfies basic regulatory requirements. The site properties that may influence the key criteria are regulatory requirements (legal condition), salinity, seal thickness, and well leakage risk. The arrows denote conditional dependencies between variables. The set of functions associated with the graph are a probability distribution for nodes: Legal (215), Salinity (220), Capacity (225), Seal Thickness (230), and Well leakage risk (235), and conditional probability distributions for nodes: No-go condition (240), Injectivity (245), Containment (250), and Storage site potential (210).

In the example of FIG. 2, in which there is no evidence, e.g., there is no known information for any node values, all values of independent variables may be set to have equal probability values. For example, in the illustrated example, the third-layer nodes include a legal condition (215), salinity (220), seal thickness (230), and well leakage risk (235). The third-layer nodes are set such that every possible output has an equal value (probability). The third-layer node values are input to the second-layer nodes that include a no-go condition (240), injectivity difficulty (245), and containment risk (250) storage site potential. The capacity node (225) is in the second plurality of nodes 130, but is an independent variable in the illustrated example, so its values are also set such that every possible output has an equal value (probability). The values of the second plurality of nodes 130, both dependent and independent variables, are input to the first-layer node, e.g., the storage site potential node (210) to calculate (or determine) whether the candidate site is a good choice for CO₂ storage. In the illustrated example of FIG. 2, in which there is no information known about the candidate site (“no evidence”), the determination would be 0 or “No go” with a 66.7% probability.

In an example Bayesian Network 300 illustrated in FIG. 3, the Bayesian Network 200 of the FIG. 2 example is used in a predictive manner to infer the storage site potential for a candidate site that has the following properties:
The geological site is in a region that allows CO₂ storage. That is, the “Legal” node 315 is in state “Allowed” with probability one (1).
The geological site has salinity between 10,000 ppm and 100,000 ppm. That is, the “Salinity” node 320 is in the state “>10,000 ppm, <100,000 ppm” with probability one (1).
The capacity is likely to be equal to or greater than what is required with equal likelihood. This is weak evidence on the “Capacity” node 325 with the probability of being in the “Equal” and “More than required” equal to 0.5.
The thickness of the caprock is approximately 50 meters (m). This is evidence that the “Seal thickness (m)” node 330 is in the state “10-100 m” with probability one (1).

A simplified Bayesian Network is shown in FIG. 3 for the Bayesian Network 300, which may be used as a predictive tool to infer storage site potential for CO₂ with evidence on the variables Legal (node 315), Salinity (node 320), Capacity (node 325), and Seal Thickness (node 330). Variables that are inferred in the FIG. 3 example include Well leakage risk (node 335), No-go condition (node 340), Injectivity (node 345), Containment (node 350), and Storage site potential (node 310). In the example scenario of FIG. 3, there is no information on the “Well leakage risk” (node 335), so equal probability may be assigned to each of the three states. The evidence may be propagated through the network, and the result for this example is that the candidate storage site satisfies basic regulatory requirements, e.g., the “No-go condition” node 340 is inferred to be in the “False” state with probability one (1), but mostly likely is undesirable for storing CO₂. In the illustrated example of FIG. 3, in which there is some information known about the candidate site as listed above, the top value for the storage site potential node (310) is 2 or “Undesirable” with a 29.0% probability. As such, the example Bayesian Network 300 may suggest that the candidate site not be used for CO₂ storage.

FIG. 4 shows an example of a simplified Bayesian Network 400 used as a diagnostic tool to infer the well leakage risk required to achieve the outcome that the storage site be desirable or very desirable with equal probability, presuming evidence on nodes: Legal (415), Salinity (420), Capacity (425), and Seal Thickness (430). For example, the storage site potential node (410) is pre-set such that the values are 4 (“Desirable”) and 5 (“Very desirable”), each with a 50.0% probability, to determine the well leakage risk (435) that should be met for a candidate site to be considered a good choice for CO₂ storage.

In the FIG. 4 example, variables without any evidence and whose values are therefore inferred may include Well leakage risk (node 435), No-go condition (node 440), Injectivity (node 445), and Containment (node 450). Well leakage risk (node 435) is a third-layer node, while No-go condition (node 440), Injectivity (node 445), and Containment (node 450) are second-layer nodes. In the example Bayesian Network 400 illustrated in FIG. 4, the Bayesian Network 200 of the FIG. 2 example may be used in a diagnostic manner to infer the required values for “Well leakage risk” (node 435) to achieve a Storage Site Potential (node 410) with equal probability for the result “Desirable” or “Very desirable”, presuming the same evidence as in the example of FIG. 3. In such a scenario, the FIG. 4 example shows that “Well leakage risk” (node 435) should be in the “Low” risk state with probability of 0.452(45.2 %) to obtain the desired Storage Site Potential (node 410).

It should be appreciated that the example variables and values illustrated for the nodes shown in the example of FIGS. 2-4 are nonlimiting. For example, other text or numerical values may be used as appropriate.

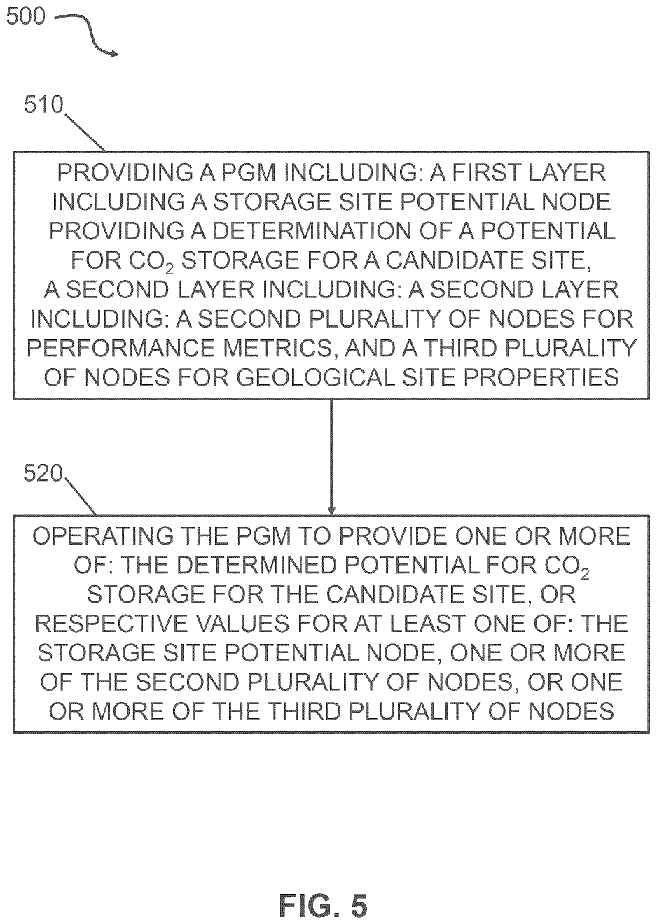

FIG. 5 is a flowchart of a method in accordance with an example embodiment of the present disclosure.

FIG. 5 illustrates a method 500. The method 500 may include, in 510, providing a probabilistic graphical model (PGM) including: a first layer including a storage site potential node providing a determination of a potential for carbon dioxide (CO₂) storage for a candidate site, and a second layer including: a second plurality of nodes, the second plurality of nodes respectively corresponding to a plurality of performance metrics, and a third plurality of nodes, the third plurality of nodes respectively corresponding to a plurality of geological site properties. Each node in the second layer may be configured to provide an input to one or more of the first layer and another node in the second layer, and the first layer is configured to receive inputs from the second layer. The method 500 may further include, in 520, operating the PGM to provide one or more of: the determination of the potential for CO₂ storage for the candidate site, or respective values for at least one of: the storage site potential node, one or more of the second plurality of nodes, or one or more of the third plurality of nodes.

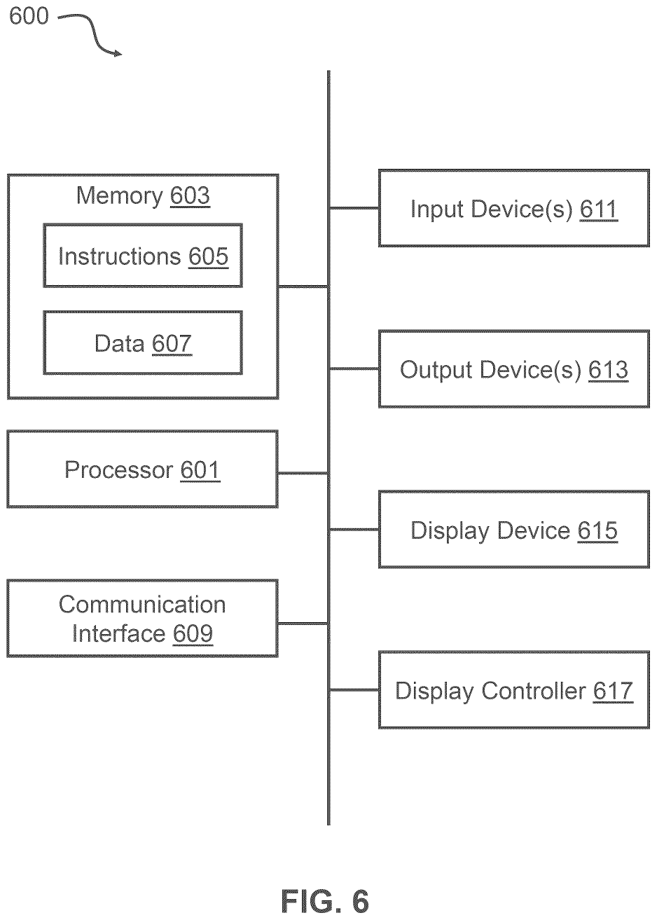

FIG. 6 illustrates certain components that may be included within a computer system according to an example embodiment of the present disclosure.

FIG. 6 illustrates certain components that may be included within a computer system 600, which may be used to control the examples of FIGS. 1-5. One or more computer systems 600 may be used to implement the various devices, components, and systems described herein.

The computer system 600 includes a processor 601. The processor 601 may be a general-purpose single-or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used. In one or more embodiments, the computer system 600 further includes one or more graphics processing units (GPUs), which can provide processing services related to both entity classification and graph generation.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

Following are sections in accordance with at least one embodiment of the present disclosure:

Clause 1: A method, including: providing a probabilistic graphical model (PGM) including: a first layer including a storage site potential node providing a determination of a potential for carbon dioxide (CO₂) storage for a candidate site, and a second layer including: a second plurality of nodes, the second plurality of nodes respectively corresponding to a plurality of performance metrics, and a third plurality of nodes, the third plurality of nodes respectively corresponding to a plurality of geological site properties, wherein: each node in the second layer is configured to provide an input to one or more of the first layer and another node in the second layer, and the first layer is configured to receive inputs from the second layer, and operating the PGM to provide one or more of: the determination of the potential for CO₂ storage for the candidate site, or respective values for at least one of: the storage site potential node, one or more of the second plurality of nodes, or one or more of the third plurality of nodes.

Clause 2: The method of clause 1, wherein: the second plurality of nodes respectively include: a capacity, a no-go condition, an injectivity difficulty, and a containment risk, and the third plurality of nodes respectively include: a legal condition, a salinity, a seal thickness, and a well leakage risk.

Clause 3: The method of clause 1, further including: setting respective values for the one or more of the third plurality of nodes to have equal probabilities, determining respective values for the one or more of the second plurality of nodes based on the set respective values for the one or more of the third plurality of nodes, and determining the values for the storage site potential node based on the determined respective values for the one or more of the second plurality of nodes.

Clause 4: The method of clause 3, further including: setting respective values for another of the one or more of the second plurality of nodes to have equal probabilities, wherein the determining the values for the storage site potential node is further based on the set respective values for the one or more of the second plurality of nodes.

Clause 5: The method of clause 1, further including: setting respective values for the one or more of the third plurality of nodes to have known probabilities, determining respective values for the one or more of the second plurality of nodes based on the set respective values for the one or more of the third plurality of nodes, and determining the values for the storage site potential node based on the determined respective values for the one or more of the second plurality of nodes.

Clause 6: The method of clause 5, further including: setting respective values for another of the one or more of the second plurality of nodes to have known probabilities, wherein the determining the values for the storage site potential node is further based on the set respective values for the one or more of the second plurality of nodes.

Clause 7: The method of clause 1, further including: setting values for the storage site potential node to have known probabilities, setting respective values for the one or more of the third plurality of nodes to have known probabilities, determining respective values for the one or more of the second plurality of nodes based on the set respective values for the one or more of the third plurality of nodes, and determining the values for another one or more of the second plurality of nodes or for another one or more of the third plurality of nodes based on the determined respective values for the one or more of the second plurality of nodes.

Clause 8: The method of clause 7, further including: setting respective values for at least a third of the one or more of the second plurality of nodes to have known probabilities, wherein the determining the values for another one or more of the second plurality of nodes or for another one or more of the third plurality of nodes is further based on the set respective values for the one or more of the second plurality of nodes.

Clause 9: The method of clause 1, further including: assigning a rank to each of a plurality of candidate sites based on the determination of the potential for CO₂ storage for each candidate site, selecting a top-ranked site among the plurality of candidate sites as a CO₂ storage site, and injecting the CO₂ into the CO₂ storage site.

Clause 10: The method of clause 9, wherein the CO₂ is injected into the CO₂ storage site as one or more of: a gas, a solid, a liquid, a supercritical fluid, or CO₂ dissolved in another fluid.

Clause 11: The method of clause 1, wherein the PGM includes one or more of: a factor graph, a Markov random field, a Bayesian network, a decision network, a causal map, or a decision tree.

Clause 12: A system, including: one or more processors, a non-transitory computer-readable medium storing instructions that, when executed, cause the one or more processors to: provide a probabilistic graphical model (PGM) including: a first layer including a storage site potential node providing a determination of a potential for carbon dioxide (CO₂) storage for a candidate site, and a second layer including: a second plurality of nodes, the second plurality of nodes respectively corresponding to a plurality of performance metrics, and a third plurality of nodes, the third plurality of nodes respectively corresponding to a plurality of geological site properties, wherein: each node in the second layer is configured to provide an input to one or more of the first layer and another node in the second layer, and the first layer is configured to receive inputs from one or more of the second layer, and operate the PGM to provide one or more of: the determination of the potential for CO2 storage for the candidate site, or respective values for at least one of: the storage site potential node, one or more of the second plurality of nodes, or one or more of the third plurality of nodes.

Clause 13: The system of clause 12, wherein: the second plurality of nodes respectively include: a capacity, a no-go condition, an injectivity difficulty, and a containment risk, and the third plurality of nodes respectively include: a legal condition, a salinity, a seal thickness, and a well leakage risk.

Clause 14: The system of clause 12, wherein the instructions further cause the one or more processors to: set respective values for the one or more of the third plurality of nodes to have equal probabilities, determine respective values for the one or more of the second plurality of nodes based on the set respective values for the one or more of the third plurality of nodes, and determine the values for the storage site potential node based on the determined respective values for the one or more of the second plurality of nodes.

Clause 15: The system of clause 14, wherein the instructions further cause the one or more processors to: set respective values for another of the one or more of the second plurality of nodes to have equal probabilities, wherein the determining the values for the storage site potential node is further based on the set respective values for the one or more of the second plurality of nodes.

Clause 16: The system of clause 12, wherein the instructions further cause the one or more processors to: set respective values for the one or more of the third plurality of nodes to have known probabilities, determine respective values for the one or more of the second plurality of nodes based on the set respective values for the one or more of the third plurality of nodes, and determine the values for the storage site potential node based on the determined respective values for the one or more of the second plurality of nodes.

Clause 17: The system of clause 16, wherein the instructions further cause the one or more processors to: set respective values for another of the one or more of the second plurality of nodes to have known probabilities, wherein the determining the values for the storage site potential node is further based on the set respective values for the one or more of the second plurality of nodes.

Clause 18: The system of clause 12, wherein the instructions further cause the one or more processors to: set values for the storage site potential node to have known probabilities, setting respective values for the one or more of the third plurality of nodes to have known probabilities, determine respective values for the one or more of the second plurality of nodes based on the set respective values for the one or more of the third plurality of nodes, and determine the values for another one or more of the second plurality of nodes or for another one or more of the third plurality of nodes based on the determined respective values for the one or more of the second plurality of nodes.

Clause 19: The system of clause 18, wherein the instructions further cause the one or more processors to: set respective values for at least a third of the one or more of the second plurality of nodes to have known probabilities, wherein the determining the values for another one or more of the second plurality of nodes or for another one or more of the third plurality of nodes is further based on the set respective values for the one or more of the second plurality of nodes.

Clause 20: The system of clause 12, wherein the instructions further cause the one or more processors to: assign a rank to each of a plurality of candidate sites based on the determination of the potential for CO₂ storage for each candidate site, select a top-ranked site among the plurality of candidate sites as a CO₂ storage site, and send a signal to an injection device to inject the CO₂ into the CO₂ storage site.

Clause 21: The system of clause 20, wherein the CO₂ is injected into the CO₂ storage site as one or more of: a gas, a solid, a liquid, a supercritical fluid, or CO₂ dissolved in another fluid.

Clause 22: The system of clause 12, wherein the PGM includes one or more of: a factor graph, a Markov random field, a Bayesian network, a decision network, a causal map, or a decision tree.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method, comprising:
providing a probabilistic graphical model (PGM) comprising:
a first layer comprising a storage site potential node providing a determination of a potential for carbon dioxide (CO₂) storage for a candidate site; and
a second layer comprising:
a second plurality of nodes, the second plurality of nodes respectively corresponding to a plurality of performance metrics; and
a third plurality of nodes, the third plurality of nodes respectively corresponding to a plurality of geological site properties,
wherein:
each node in the second layer is configured to provide an input to one or more of the first layer and another node in the second layer, and
the first layer is configured to receive inputs from the second layer; and
operating the PGM to provide one or more of:
the determination of the potential for CO₂ storage for the candidate site; or
respective values for at least one of:
the storage site potential node;
one or more of the second plurality of nodes; or
one or more of the third plurality of nodes.

2. The method of claim 1, wherein:
the second plurality of nodes respectively comprise:
a capacity;
a no-go condition;
an injectivity difficulty; and
a containment risk; and
the third plurality of nodes respectively comprise:
a legal condition;
a salinity;
a seal thickness; and
a well leakage risk.

3. The method of claim 1, further comprising:
setting respective values for the one or more of the third plurality of nodes to have equal probabilities;
determining respective values for the one or more of the second plurality of nodes based on the set respective values for the one or more of the third plurality of nodes; and
determining the values for the storage site potential node based on the determined respective values for the one or more of the second plurality of nodes.

4. The method of claim 3, further comprising:
setting respective values for another of the one or more of the second plurality of nodes to have equal probabilities,
wherein the determining the values for the storage site potential node is further based on the set respective values for the one or more of the second plurality of nodes.

5. The method of claim 1, further comprising:
setting respective values for the one or more of the third plurality of nodes to have known probabilities;
determining respective values for the one or more of the second plurality of nodes based on the set respective values for the one or more of the third plurality of nodes; and
determining the values for the storage site potential node based on the determined respective values for the one or more of the second plurality of nodes.

6. The method of claim 5, further comprising:
setting respective values for another of the one or more of the second plurality of nodes to have known probabilities,
wherein the determining the values for the storage site potential node is further based on the set respective values for the one or more of the second plurality of nodes.

7. The method of claim 1, further comprising:
setting values for the storage site potential node to have known probabilities;
setting respective values for the one or more of the third plurality of nodes to have known probabilities;
determining respective values for the one or more of the second plurality of nodes based on the set respective values for the one or more of the third plurality of nodes; and
determining the values for another one or more of the second plurality of nodes or for another one or more of the third plurality of nodes based on the determined respective values for the one or more of the second plurality of nodes.

8. The method of claim 7, further comprising:
setting respective values for at least a third of the one or more of the second plurality of nodes to have known probabilities,
wherein the determining the values for another one or more of the second plurality of nodes or for another one or more of the third plurality of nodes is further based on the set respective values for the one or more of the second plurality of nodes.

9. The method of claim 1, further comprising:
assigning a rank to each of a plurality of candidate sites based on the determination of the potential for CO₂ storage for each candidate site;
selecting a top-ranked site among the plurality of candidate sites as a CO₂ storage site; and
injecting the CO₂ into the CO₂ storage site.

10. The method of claim 9, wherein the CO₂ is injected into the CO₂ storage site as one or more of: a gas, a solid, a liquid, a supercritical fluid, or CO₂ dissolved in another fluid.

11. The method of claim 1, wherein the PGM comprises one or more of: a factor graph, a Markov random field, a Bayesian network, a decision network, a causal map, or a decision tree.

12. A system, comprising:
one or more processors;
a non-transitory computer-readable medium storing instructions that, when executed, cause the one or more processors to:
provide a probabilistic graphical model (PGM) comprising:
a first layer comprising a storage site potential node providing a determination of a potential for carbon dioxide (CO₂) storage for a candidate site; and
a second layer comprising:
a second plurality of nodes, the second plurality of nodes respectively corresponding to a plurality of performance metrics; and
a third plurality of nodes, the third plurality of nodes respectively corresponding to a plurality of geological site properties,
wherein:
each node in the second layer is configured to provide an input to one or more of the first layer and another node in the second layer, and
the first layer is configured to receive inputs from the second layer; and
operate the PGM to provide one or more of:
the determination of the potential for CO₂ storage for the candidate site; or
respective values for at least one of:
the storage site potential node;
one or more of the second plurality of nodes; or
one or more of the third plurality of nodes.

13. The system of claim 12, wherein:
the second plurality of nodes respectively comprise:
a capacity;
a no-go condition;
an injectivity difficulty; and
a containment risk; and
the third plurality of nodes respectively comprise:
a legal condition;
a salinity;
a seal thickness; and
a well leakage risk.

14. The system of claim 12, wherein the instructions further cause the one or more processors to:
set respective values for the one or more of the third plurality of nodes to have equal probabilities;
determine respective values for the one or more of the second plurality of nodes based on the set respective values for the one or more of the third plurality of nodes; and
determine the values for the storage site potential node based on the determined respective values for the one or more of the second plurality of nodes.

15. The system of claim 14, wherein the instructions further cause the one or more processors to:
set respective values for another of the one or more of the second plurality of nodes to have equal probabilities,
wherein the determining the values for the storage site potential node is further based on the set respective values for the one or more of the second plurality of nodes.

16. The system of claim 12, wherein the instructions further cause the one or more processors to:
set respective values for the one or more of the third plurality of nodes to have known probabilities;
determine respective values for the one or more of the second plurality of nodes based on the set respective values for the one or more of the third plurality of nodes; and
determine the values for the storage site potential node based on the determined respective values for the one or more of the second plurality of nodes.

17. The system of claim 16, wherein the instructions further cause the one or more processors to:
set respective values for another of the one or more of the second plurality of nodes to have known probabilities,
wherein the determining the values for the storage site potential node is further based on the set respective values for the one or more of the second plurality of nodes.

18. The system of claim 12, wherein the instructions further cause the one or more processors to:
set values for the storage site potential node to have known probabilities;
set respective values for the one or more of the third plurality of nodes to have known probabilities;
determine respective values for the one or more of the second plurality of nodes based on the set respective values for the one or more of the third plurality of nodes; and
determine the values for another one or more of the second plurality of nodes or for another one or more of the third plurality of nodes based on the determined respective values for the one or more of the second plurality of nodes.

19. The system of claim 18, wherein the instructions further cause the one or more processors to:
set respective values for at least a third of the one or more of the second plurality of nodes to have known probabilities,
wherein the determining the values for another one or more of the second plurality of nodes or for another one or more of the third plurality of nodes is further based on the set respective values for the one or more of the second plurality of nodes.

20. The system of claim 12, wherein the instructions further cause the one or more processors to:
assigning a rank to each of a plurality of candidate sites based on the determination of the potential for CO₂ storage for each candidate site;
select a top-ranked site among the plurality of candidate sites as a CO₂ storage site; and
send a signal to an injection device to inject the CO₂ into the CO₂ storage site.

21. The system of claim 20, wherein the CO₂ is injected into the CO₂ storage site as one or more of: a gas, a solid, a liquid, a supercritical fluid, or CO₂ dissolved in another fluid.

22. The system of claim 12, wherein the PGM comprises one or more of: a factor graph, a Markov random field, a Bayesian network, a decision network, a causal map, or a decision tree.
